(19) United States
(12) Patent Application Publication
(10) Pub. No.: US 2023/0059820 A1
(43) Pub. Date: Feb. 23, 2023

(54) METHODS AND APPARATUSES FOR RESOURCE MANAGEMENT OF A NETWORK CONNECTION TO PROCESS TASKS ACROSS THE NETWORK

(71) Applicant: XFUSION DIGITAL TECHNOLOGIES CO., LTD, Zhengzhou City (CN)

(72) Inventors: Victor GISSIN, Zhengzhou (CN); Junying LI, Zhengzhou (CN); Elena GUREVICH, Zhengzhou (CN); Huichun QU, Zhengzhou (CN)

(21) Appl. No.: 17/966,054

(22) Filed: Oct. 14, 2022

Related U.S. Application Data
(63) Continuation of application No. PCT/CN2020/085429, filed on Apr. 17, 2020.

(51) Int. Cl. G06F 9/50

(52) U.S. Cl. CPC G06F 9/5038; G06F 9/5016

(57) ABSTRACT

Network interface cards (NICs), a network apparatus and a method thereof are disclosed. A NIC comprises: a memory configured to assign a directing context and a network context denoting dynamically allocated resources. The directing context is associated with the network context, and the directing context is associated with queues queueing tasks and designated for execution using a network connection. The NIC further comprises a NIC processing circuitry, which is configured to process the tasks using the steering and network contexts. The directing context is temporarily assigned for use by the network connection during tasks execution, and the network context is assigned for use by the network connection during a lifetime of the network connection. In response to completing execution of the tasks, the association of the directing context with the network context is released while maintaining the assignment of the network context until the network connection is terminated.

### CROSS-REFERENCE TO RELATED APPLICATIONS

This application is a continuation of International Patent Application No. PCT/CN2020/085429, filed on Apr. 17, 2020, which is hereby incorporated by reference in its entirety.

### TECHNICAL FIELD

The present disclosure, in some embodiments thereof, relates to resources of network connections and, more specifically, but not exclusively, to methods and apparatuses for resources management of a network connection to process tasks across the network.

### BACKGROUND

A network node, for example a server, may establish and simultaneously support thousands of network connections to other network nodes, such as storage servers, endpoint devices, and other servers in order to provide exchange of application data or execute application tasks across the network between network nodes over network connections. The large number of simultaneous network connections consumes significant amount of resources at the network node, including: memory resources for managing delivery tasks related information to/from an application running at the network node (e.g., queues); memory resources for storing network protocol related information (e.g. state parameters), for providing guaranteed delivery of the task and/or data in order over the network connection, for handling, monitoring and mitigating different network condition such as data loss, reordering, congestion, and etc.; and computational resources for processing of network protocols used to process tasks or transfer of data over the network connection.

### SUMMARY

It is an object of the present disclosure to provide a network interface card (NIC) for data transfer across a network, a network apparatus including at least one NIC, a method of management of resources consumed by a network connection for processing of tasks across a network, a computer program product and/or a computer readable medium storing code instructions executable by one or more hardware processors for management of resources consumed by network connections for processing of tasks across a network.

The foregoing and other objects are achieved by the features of the independent claims. Further implementation forms are apparent from the dependent claims, the description and the figures.

According to a first aspect of the present disclosure, a network interface card (NIC) for data transfer across a network is disclosed. The NIC comprises: a memory, which is configured to assign a directing context denoting a first dynamically allocated memory resource and assign a network context denoting a second dynamically allocated memory resource. The directing context is associated with the network context (e.g. by an external processor), and the directing context is associated with at least one queue queueing a plurality of tasks (e.g. initiated by an application). The plurality of tasks are posted (e.g. by the external processor) and designated for execution using a certain network connection. The NIC further comprises a NIC processing circuitry, which is configured to process the plurality of tasks using the directing context and the network context. The directing context is assigned (for example, temporarily) for use by the certain network connection during execution of the plurality of tasks, and the network context is assigned for use by the certain network connection during a lifetime of the certain network connection. In response to an indication of completing execution of the plurality of tasks, the association of the directing context with the network context is released (e.g. by the external processor) while maintaining the assignment of the network context until the certain network connection is terminated.

According to a second aspect of the present disclosure, a NIC for data transfer across a network is disclosed. The NIC comprises: a memory, which is configured to assign a directing context denoting a first dynamically allocated memory resource and assign a network context denoting a second dynamically allocated memory resource. The directing context is associated with at least one queue queuing a plurality of tasks, and the plurality of tasks are received across the network from an initiator network node over a certain network connection. The NIC further comprises a NIC processing circuitry, and the NIC processing circuitry is configured to associate the directing context with the network context, and queue the plurality of tasks into at least one queue associated with the directing context. The directing context is assigned (for example, temporarily) for use by a certain network connection during execution of the plurality of tasks, and the network context is assigned for use by the certain network connection during a lifetime of the certain network connection. In response to an indication of completing execution of the plurality of tasks, the association of the directing context with the network context is released while the assignment of the network context is maintained until the certain network connection is terminated.

Memory resources of a network connection are divided into two independent parts—a first part (referred to herein as a network context) and a second part (referred to herein as a directing context). The first part, i.e. the network context is used during the entire time when the network connection is alive (i.e. the network context is released until the connection is terminated), and the second part, i.e. the directing context is used only during processing of one or more tasks using the network connection.

An amount of the established network connections that may simultaneously process/execute tasks across the network is determined according to a certain network bandwidth, a certain network delay and a computational performance of the networking node to which the network connecting device is attached. In a high-scale system which comprises hundreds of thousands of the established network connections, only few of them may be used to transfer data simultaneously. Memory resources for allocation of network contexts are reserved according to an estimated amount of established network connection. Memory resources for the allocation of the directing contexts are reserved according to an estimated amount of the network connections that may be used concurrently to perform tasks processing. Since the amount of the directing context is significantly less than the amount of the network contexts, the total memory which is reserved for use by the network connections of a network device can be significantly reduced.

An amount of memory reserved to implement a queue should be enough to accommodate an amount of task related information providing a required throughput over a certain network connection. Since directing context is associated with a set of queues, and in high-scale system, an amount of estimated directing contexts is significantly less than an amount of the estimated network contexts, at least some aspects and/or implementation forms described herein achieve a significant reduction of the total memory which is reserved for memory resources allocation of the plurality of the network connections.

At least some implementations of the first and second aspects described herein may provide a transfer of data over the network connections using different types of reliable transport protocols, for example, RC/XRC (Reliable Connection/eXtended Reliable Connection) of RoCE (Remote Direct Memory Access (RDMA) over Converged Ethernet), TCP (Transmission Control Protocol), and CoCo (TCP with Connection Cookie extension).

In a further implementation form of the first and second aspects, the directing context is further configured to store a plurality of first state parameters. The plurality of first state parameters are used by the certain network connection during execution of the plurality of tasks queued in the at least one queue associated with the directing context.

First state parameters may be used, for example, to deliver task related information using set of queues, and/or to handle disorder of the arrived packets, loss recovery and retransmission.

In a further implementation form of the first and second aspects, an amount of the memory resources reserved for the allocation of the directing context is determined by a first estimated number of established network connections that are predicted to simultaneously execute respective tasks.

Reserving memory resources according to the estimated number of network connections predicted to simultaneously executing respective tasks can significantly reduce total memory which is reserved, since the number of connections simultaneously executing tasks is predicted to be much less than the number of established network connections.

In a further implementation form of the first aspect and second aspects, the network context is configured to store a plurality of second state parameters for the certain network connection in the network context, wherein the plurality of second state parameters are maintained and used by the certain network connection during a whole lifetime of the certain network connection.

Second state parameters may be used, for example, to provide transport of packets across the network, and/or network monitoring, congestion mitigation in the network. Examples of second state parameters include: Round trip time (RTT)/Latency, available and reached rates.

In a further implementation form of the first and second aspects, an amount of memory resources reserved for the allocation of the network context is determined by a second estimated number of concurrently established network connections.

Dividing the amount of reserved memory resource into the network context and the directing context significantly reduces overall total memory resources that are reserved. For example, since in a high-scale system, the number of network connections that are concurrently transferring data, which are allocated directing context, is significantly less than the total number of network connections which are allocated network context. A reduction in reserved memory is achieved by the amount of predicted directing contexts that is significantly less than the amount of predicted network contexts. Since the amount of the directing context is significantly less than the amount of the network contexts, the total memory which is reserved for use by the network connections can be significantly reduced.

In a further implementation form of the first and second aspects, a network context identifier (NCID) is assigned to the network context and a directing context identifier (SCID) is assigned to the directing context. By assigning a NCID to the network context and assigning a SCID to the directing context, it is easier to identify different network contexts and different directing contexts with regard to different network connections.

In a further implementation form of the first and second aspects, the at least one queue is used to deliver task related information originated from the NIC processing circuitry and/or destined to the NIC processing circuitry, wherein a Queue Element of the at least one queue includes a task related information of the plurality of tasks using the certain network connection together with a respective NCID.

Including the NCID in the queue element (QE) may improve processing efficiency, since NCID of the network context associated with the queue element is immediately available and does not require additional access to the mapping dataset to obtain the NCID.

In a further implementation form of the first and second aspects, the memory is configured to store a mapping dataset that maps between the NCID of the network context and the SCID of the directing context. By storing the mapping dataset, it is easier to determine a corresponding NCID based on a known SCID.

In a further implementation form of the first aspect, the external processor may be implemented as external to the NIC, for example, a processor of a host to which the NIC is attached. Communication between the NIC and the external processor may be, for example, using a software interface over a peripheral component interconnect express (PCIe) bus. Alternatively, in another implementation of the first aspect, the external processor may be implemented within the NIC itself, for example, the NIC and external processor are deployed on a same hardware board.

The external processor is configured to: determine start of processing of a first task of the plurality of tasks using a certain network connection; allocate a directing context from the plurality of the memory resources for use by the certain network connection; and associate the directing context having a certain SCID with the network context having a certain NCID by creating a mapping between the respective NCID and SCID in response to the determined start, wherein all of the plurality of tasks are processed using the same mapping.

In a further implementation form of the first aspect, the external processor is configured to: determine completion of a last task of the plurality of tasks, and in response to the determined completion, release the association of the directing context with the network context by removing the mapping between the NCID and the SCID and release the directing context.

The ability to determine the start and/or completion of the tasks execution enables the temporary assigning of the directing context for use during the execution of the tasks.

In a further implementation form of the first aspect, the NIC is implemented on an initiator network node that initiates the plurality of tasks using the certain network connection to a target network node, wherein the plurality of tasks is received by the external processor from an application running on the initiator network node.

At least some aspects and/or implementations described herein may be implemented on both an initiator network node and a target network node, only on the initiator network node, or only on the target network node. When the NIC is implemented on the initiator node, the external processor associates the directing context with the network context, and posts the tasks to the queues associated with the directing context. The NIC processing circuitry processes the tasks using the directing context and the network context. When the NIC is implemented on the target node, the NIC processing circuitry associates the directing context with the network context and queues the tasks into the queues associated with the directing context. The implementation that is used by a certain network node acting as initiator is not dependent on the implementation that is used by another network node acting as target. When the NIC is implemented at both initiator and target network nodes, such implementation may be performed independently at each end. Implementation at one end of a network connection (i.e., at the initiator network node) does not require the cooperation of the other end of the network connection (i.e., at the target network node).

In a further implementation form of the second aspect, the NIC processing circuitry is configured to: determine start of processing of a first task of the plurality of tasks using the certain network connection, and allocate the directing context from the plurality of the memory resources for use by the certain network connection and associate the directing context having a certain SCID with the network context having a certain NCID by creating a mapping between the NCID and the SCID in response to the determined start, wherein all of the plurality of tasks are processed using the same mapping.

In a further implementation form of the second aspect, the NIC processing circuitry is configured to: determine completion of a last task of the plurality of tasks, and in response to the determined completion, release the association of the directing context with the network context by removing the mapping between the NCID and the SCID and release the directing context.

The ability to determine the start and/or completion of the tasks execution enables the temporary assigning of the directing context for use during the execution of the tasks.

In a further implementation form of the second aspect, the NIC is implemented on a target network node that executes and responds to the plurality of tasks received across the network over the certain network connection from the initiator network node.

According to a third aspect of the present disclosure, a network apparatus is also disclosed. The network apparatus comprises at least one NIC according to any of the first and second aspects and their implementations.

In a further implementation form of the third aspect, the network apparatus further comprises: at least one external processor which is configured to: determine start of processing of a first task of the plurality of tasks using a certain network connection, allocate a directing context from the plurality of the memory resources for use by the certain network connection, and associate the directing context having a certain SCID with the network context having a certain NCID by creating a mapping between the respective NCID and SCID in response to the determined start. As an alternative of the implementation, all of the plurality of tasks are processed using the same mapping.

Using the same mapping between the NCID and the SCID or all of the tasks improves processing efficiency of the tasks by utilizing the same allocated network and directing context.

In a further implementation form of the third aspect, the external processor is configured to: determine completion of a last task of the plurality of tasks, and in response to the determined completion, release the association of the directing context with the network context by removing the mapping between the NCID and the SCID and release the directing context. Releasing the directing context together with the associated queries for reuse by another network connection for execution of the tasks of the other network connection improves memory utilization.

According to a fourth aspect of the present disclosure, a method of management of resources consumed by a network connection for processing of tasks across a network is disclosed. The method comprises: providing a directing context denoting a first dynamically allocated memory resource and providing a network context denoting a second dynamically allocated memory resource, wherein the directing context is associated with the network context, and the directing context is associated with at least one queue queueing a plurality of tasks, wherein the plurality of tasks are designated for execution using a certain network connection; assigning (for example, temporarily) the directing context for use by the certain network connection during execution of the plurality of tasks, assigning the network context for use by the certain network connection during a lifetime of the certain network connection; processing the plurality of tasks using the directing context and the network context; and in response to an indication of completing execution of the plurality of tasks, releasing the association of the directing context with the network context while maintaining the assignment of the network context until the certain network connection is terminated.

The method according to the fourth aspect can be extended into implementation forms corresponding to the implementation forms of the first apparatus according to the first aspect. Hence, an implementation form of the method comprises the feature(s) of the corresponding implementation form of the first apparatus or the second aspect.

The advantages of the methods according to the fourth aspect are the same as those for the corresponding implementation forms of the first apparatus according to the first aspect or the second aspect.

Unless otherwise defined, all technical and/or scientific terms used herein have the same meaning as commonly understood by a person of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example and for purposes of illustrative discussion of embodiments of the present disclosure. In this regard, the description taken with the drawings makes apparent to those skilled in the art how embodiments of the present disclosure may be practiced.

In the drawings:

FIG. 1A is a schematic of an exemplary implementation of a network node that includes a NIC, in accordance with some embodiments;

FIG. 1B is a schematic of an exemplary implementation of a NIC, in accordance with some embodiments;

FIG. 1C is a schematic of a NIC implemented on a network node acting as an initiator communicating over a packet network with another instance of the NIC implemented on a network node acting as a target, in accordance with some embodiments;

FIG. 2 is a flowchart of a method of management of resources consumed by a network connection for processing of tasks across a network, in accordance with some embodiments;

FIG. 3 includes exemplary pseudocode for implementation of exemplary atomic operations executable by the mapping dataset, in accordance with some embodiments;

FIG. 4, which includes exemplary pseudocode for implementation of exemplary operations executable by the mapping dataset in accordance with some embodiments;

FIG. 5 is a diagram depicting an exemplary processing flow in an initiator network node that includes the NIC described herein, in accordance with some embodiments; and

FIG. 6 is a processing flow diagram depicting an exemplary processing flow in a target network node that includes the NIC described herein, in accordance with some embodiments.

### DETAILED DESCRIPTION

The present disclosure, in some embodiments thereof, relates to resources of network connections and, more specifically, but not exclusively, to methods and apparatuses for resource management consumed by a network connection to process tasks across a network.

An aspect of some embodiments relates to a NIC implemented on an initiator network node. The NIC is designed for communicating across a network using a certain network connection with another implementation of the NIC implemented on a target network node. The NIC implemented on the initiator network node and the NIC implemented on the target network node each include a memory that assigns a directing context denoting a first dynamically allocated memory resource and assigns a network context denoting a second dynamically allocated memory resource. At the initiator network node, the directing context is associated with the network context by an external processor. The directing context is associated with one or more queues queueing tasks posted by the external processor and designated for execution using the certain network connection. At the initiator network node, an NIC processing circuitry processes the tasks using the directing context and the network context. The directing context is temporarily assigned for use by the certain network connection during execution of the tasks. The network context is assigned for use by the certain network connection during a lifetime of the certain network connection. The initiator network node runs an application that initiates the tasks using the certain network connection to the target network node. At the target network node, the NIC processing circuitry of the target network node associates the directing context with the network context and queues the tasks into one or more queues associated with the directing context. The target network node executes and responds to the tasks received across the network over the certain network connection from the initiator network node. The tasks may be executed, for example, by the NIC processing circuitry of the target network node, by an external processor of the target network node, by an application running on the target network node, and/or combination of the aforementioned. In response to an indication of completing execution of the tasks, the association of the directing context with the network context is released while maintaining the assignment of the network context until the certain network connection is terminated. At the initiator network node, the release is performed by the external processor, at the target network node, the release is performed by the NIC processing circuitry.

At least some implementations of the methods and apparatuses described herein address the technical problem of a significant amount of memory resources being reserved for established network connections. The reserved memory is actually used only during the task processing time intervals, and not used but is still reserved when there is no task processing. Hence, the large amount of memory reserved in advance for contexts and/or queues is wasted when it is not being used by network connection actually processing the tasks since only a small amount of the reserved memory is actually used. The amount of memory that needs to be reserved for one occupying network connection in advance may be large, and with the number of established connections grow, the amount of memory that needs to be reserved in advanced are huge, and shortage of memory resources becomes a limiting factor for some deployments. Table 1 below provides a breakdown for estimating the amount of memory that is reserved for established network connections of an exemplary network node running 100000 connections over RoCE transport (e.g., high-scale system). Memory is reserved for 2,880,000 outstanding tasks.

TABLE 1

| parameter | value |
|---|---|
| Send queue (SQ) depth | 256 |
| Send queue element (SQE) size (Byte) | 64 |
| SQ size (Byte) | 16384 |
| Inbound request queue (IRQ) depth | 32 |
| Inbound request queue element (IRQE) size (Byte) | 32 |
| IRQ size (Bytes) | 1024 |
| Remote Direct Memory Access (RDMA) over | 512 |
| Converged Ethernet (RoCE) context (Bytes) | |
| total memory per Queue pair (QP) (Bytes) | 17,920 |
| # of connections per node | 100,000 |
| # of outstanding tasks | 2,880,000 |
| Total memory (Mbyte) | 1,792 |

Out of the 100,000 established network connections, the number of connections that are simultaneously processing of tasks is significantly small. The number of network connections simultaneously processing tasks is limited, for example, by computational performance of the network connection nodes, the properties of the network—network bandwidth and network latency. Table 1 presents values for an example storage network node that is connected to a network using a network interface with a bandwidth of 200 Gigabytes per second (Gb/s) and having 200 nanosecond (ns) round-trip latency, may simultaneously provide not more than 1221 task' requesting to process 4 KB data units. On the other hand, in order to guarantee a desired throughput for each network connection, the corresponding send queue (SQ), receive queue (RQ) and completion queue (CQ) should each include a sufficient number of elements to accommodate the desired amount of posted request/response/completions for the tasks. The SQ includes sending queue elements, which are used to deliver data, and/or task requests/responses. The RQ includes receiving queue elements, which are used to deliver data, and/or task requests/responses. The CQ is used to report the completions of those queue elements. The biggest part of the memory consumption described herein, are queues allocated to guarantee the desired throughput of each network connection. As the number of queues is increased, the amount of reserved memory increases, leading to a queue scalability issue. At least some implementations of the methods and apparatuses described herein provide technical advantages over other existing standard approaches to solve the above mentioned technical problem.

One standard approach to solve the queue scalability issue is based on implementing a virtual queue, which is a list of linked elements. However, since the queues are located out of the NIC (for example, in the memory of a main CPU of the network node), effectiveness of DMA method to such queue depends on a number of accesses. Since number of accesses to the linked elements of the queue is O(n), while a number of accesses to the physically continuous elements of the queue NIC is O(n/m), where ‘n’ denotes the number of elements in the queue and ‘m’ denotes a size of the cache line at least some implementations of the methods and apparatuses described herein enable employing a physically continuous queue which significantly reduces the number of accesses to the queues.

Examples of other standard approaches to solve the queue scalability issue include a shared queue types specified by InfiniBand Architecture and introduced for use by RDMA technology: for example, the shared receive queue (SRQ) and the shared completion queue (SCQ) and extended reliable connected (XRC) transport service. However, deployment of such types of shared queues addresses queue scalability issue at receiver side only and leaves unanswered context scalability issue. In contrast, at least some implementation described herein provide one or more queues associated with the directing context temporarily assigned for use by the network connection during execution of the tasks, which addresses the queue and context scalability issue at both—receiver and sender sides. The other approach is applicable for RDMA technologies only. In contrast, at least some implementations described herein provide processing of tasks using different types of reliable transport protocols, for example, RC/XRC, RoCE, TCP, and CoCo.

Another approach (Dynamically Connected Transport Service) reduces the size of the required memory for both the connection contexts and Send queues, and suffers from the following flaws, which are solved by at least some implementations described herein:
The single SQ services multiple network connections is what creates the head of the line blocking in the other approach. In contrast, at least some implementation described herein provide one or more queues dedicate to each network connection that prevents head of the line blocking.
The other approach requires the support of dynamically connected transport (DCT) in both peers of the connection. In contrast, at least some embodiments described herein do not necessarily require implementation at both initiator node and target nodes, for example, some embodiments are for implementation at the initiator node but not at the target node, and other embodiments are for implementation at the target node but not at the initiator node. It is noted that some embodiments are for implementation at both initiator and target.
The other approach doesn't inherit the network status between successive transactions of the same pair of network nodes, what makes it inapplicable for the congested network. In contrast, at least some implementation described herein provide a network context which stores second state parameters used for network monitoring of congestion mitigation in the network. The second state parameters are maintained and used by the certain network connection during a whole lifetime of the certain network connection.
The other approach is applicable for InfiniBand (IB) only (not TCP and even RoCE). In contrast, at least some implementations described herein provide processing of tasks using different types of reliable transport protocols, for example, RC/XRC, RoCE, TCP, and CoCo.

At least some implementations of the methods and apparatuses described herein significantly reduce memory requirements of a network node (e.g., high-scale distributed system) for establishing network connections. The memory requirements are reduced at least by reserving memory resources for allocation of directing contexts according to an estimated amount of established network connections that may concurrently perform task processing. The amount of memory reserved for the directing context is significantly less than the amount of total memory which would otherwise be reserved for use by all existing the network connections.

Table 2 below provides values used to compute the values in Table 4.

TABLE 2

| parameter | value |
|---|---|
| total bandwidth (Gbs) | 200 |
| latency | 200 |
| task size (KB) | 4 |
| # of Outstanding tasks | 1221 |

Table 3 below estimates per sub-context type memory utilization for a network node running 100000 network connections for processing of tasks. The per sub-context memory types are described below in additional detail.

TABLE 3

| parameter | Value in bytes |
|---|---|
| Host queue context | 265 |
| User-data delivery context | 128 |
| Connection context | status |

Table 4 below summarizes parameters of an exemplary network node running 100000 connections (e.g., high-scale system), which is able to support an estimated 1221 network connections simultaneously actively processing tasks only. Table 4 shows that the actual amount of outstanding tasks is 1221, where the size of each transfer unit of the tasks is 4 KB. Comparing Table 1 and 4, the amount of reserved memory is good for 2,880,000 tasks, while in contrast, there are only 1221 tasks that are actually being concurrently executed.

TABLE 4

| | |
|---|---|
| Total bandwidth (Gbs) | 200 |
| # connections (K) | 100 |
| Connection bandwidth (Gbs) | 25 |
| Latency (us) | 200 |
| Data size (KB) | 4 |
| Outstanding tasks (#) | 1221 |
| Host queue context (B) | 256 |
| User-data delivery context (B) | 128 |
| Connection status context (B) | 128* |
| WQE Min | 64 |
| WQE max size | 640 |
| Send queue depth (#) | 256 |

Table 5 below compares the standard approach of reserving memory for all 100000 connections (row denoted ‘Fully Equipped’) and memory used by at least some implementations of the methods and apparatuses described herein (row denoted ‘Really in use’). At least some implementations describe herein improve memory utilization, by reducing the amount of memory used to only about 2.2% of the amount of memory used by standard processes that reserve memory for all established connections.

TABLE 5

| | | Sub-contexts in MB | | | | Send |
|---|---|---|---|---|---|---|
| | | | User | Connec- | # | queue |
| | Total | Host | data | tion | outstand- | size |
| | in MB | queue | delivery | Status | ing IO | in (MB) |
| Fully | 1614 | 25 | 13 | 13 | 25400000 | 1563 |
| equipped | | | | | | |
| Really in | 35 (2.2%) | 1 | 1 | 13 | 1250 | 20 |
| use | | | | | | |

Before explaining at least one embodiment of the present disclosure in detail, it is to be understood that the present disclosure is not necessarily limited in its application to the details of construction and the arrangement of the components and/or methods set forth in the following description and/or illustrated in the drawings and/or the Examples. The present disclosure is capable of other embodiments or of being practiced or carried out in various ways.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

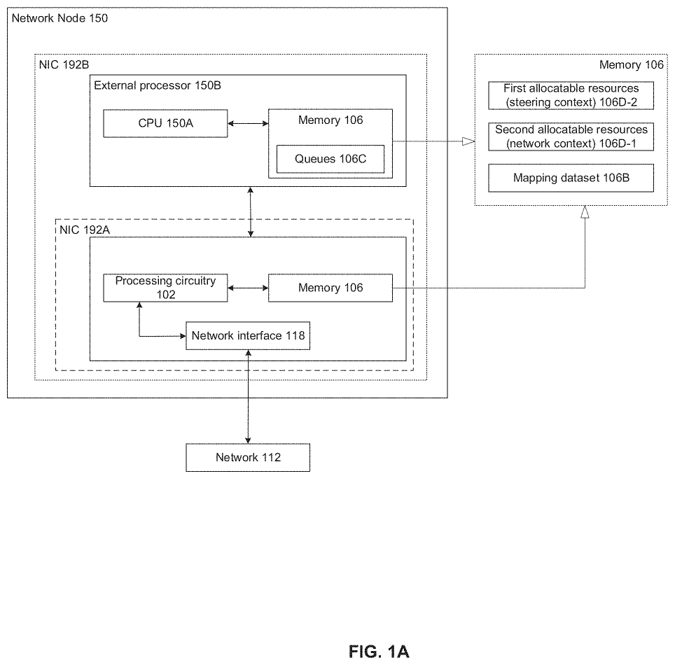

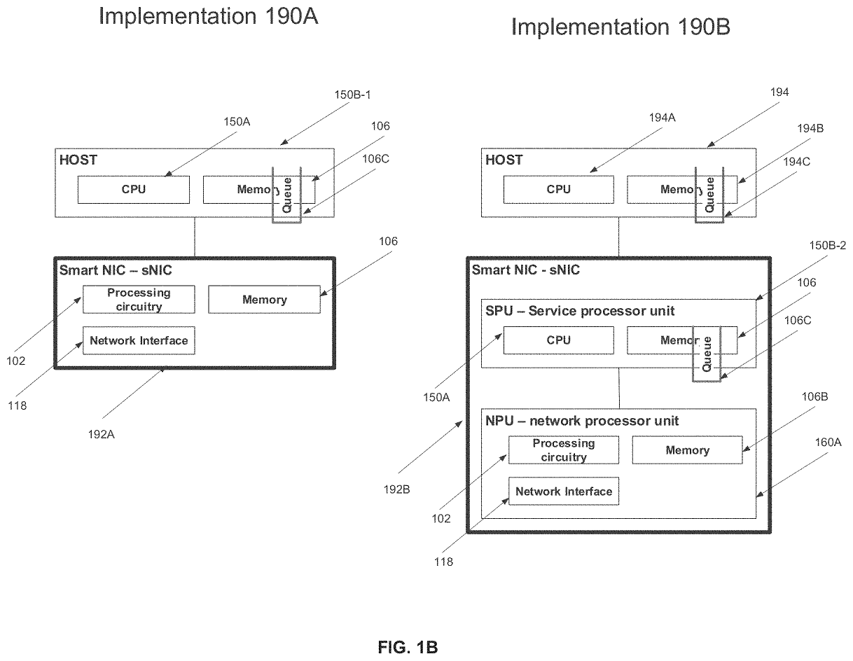

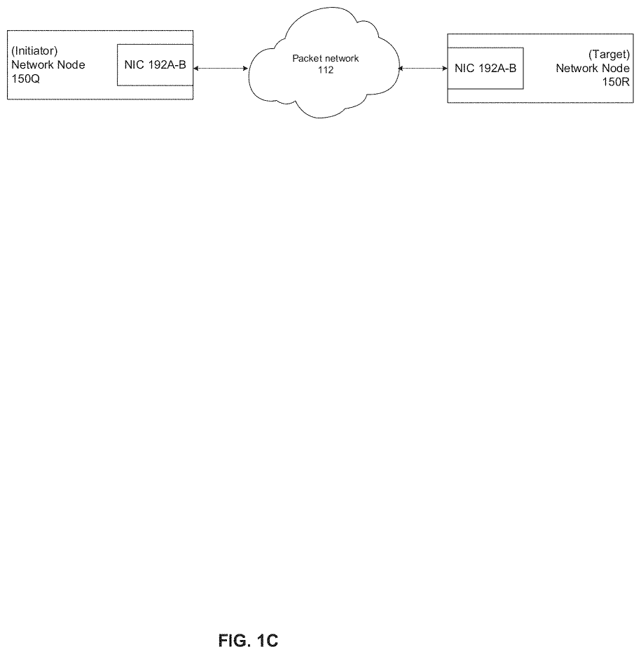

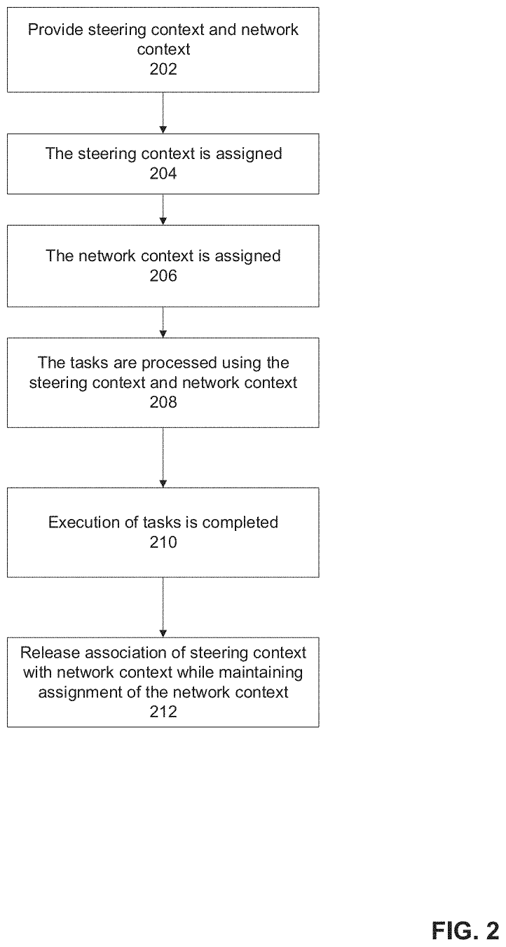

Reference is now made to FIG. 1A, which is a schematic of an exemplary implementation of a network node 150 that includes a NIC 192A or a NIC 192B, in accordance with some embodiments. Reference is also made to FIG. 1B, which is a schematic of an exemplary implementation 190A of NIC 192A and an exemplary implementation 190B of NIC 192B, in accordance with some embodiments. Reference is also made to FIG. 1C, which is a schematic of NIC 192A-B implemented on a network node 150 acting as an initiator 150Q communicating over a packet-based network 112 with another instance of NIC 192A-B implemented on a network node acting as a target 150R, in accordance with some embodiments. It is noted that each node 150 may act as the initiator, as the target, or both initiator and target. Reference is also made to FIG. 2, which is a flowchart of a method of management of resources consumed by a network connection for processing of tasks across a network, in accordance with some embodiments. The method described with reference to FIG. 2 is implemented by a network node acting as an initiator, and/or a network node acting as a target that includes the NIC described with reference to FIG. 1A-1C.

The NIC 192A and the NIC 192B can reduce the amount of memory consumed by a network connection for processing of tasks across a network.

A memory resource of established connection are divided into two independent parts—the first part (referred to herein as a network context) is used during the entire time the established connection is alive. The second part (referred to herein as a directing context) is used only during processing of task using network connection. Also set of queues queueing task related information are associated with a directing context.

An amount of the established network connections that may simultaneously process tasks across the network is limited by a certain network bandwidth and a certain network delay and a computational performance of the networking node to which the network connecting device is attached. In a high-scale system which comprises hundreds of thousands of the established network connections only few of them may process tasks simultaneously. A memory for allocation of network contexts is reserved according to the estimated amount of established connection. A memory for the allocation of the directing contexts is reserved according to the estimated amount of the established connections may concurrently perform tasks processing. Since amount of the directing context is significantly less than an amount of the network contexts we achieve significant reduction of the total memory which is reserved for use by the network connections.

The NIC 192A or the NIC 192B is implemented as a network interface card, for example, that plugs into a slot, and/or is integrated within a computing device. The NIC 192A-B may be implemented for example, using ASIC and/or FPGA, with embedded or external (on the board) processors for the programmability of the data-plane. The NIC 192A-B may be designed to offload processing of tasks that the main CPU of the network node would normally handle. The NIC 192A-B may be able to perform any combination of TCP/IP and HTTP, RDMA processing, encryption/decryption, firewall, and the like. The NIC 192A-B may be implemented in a network node 150 acting as an initiator 150Q (also referred to herein as initiator network node), and/or in a network node 150 acting as a target 150R (also referred to herein as a target network node), as shown in FIG. 1C. The initiator network node (150Q in FIG. 1C) runs an application that initiates the tasks using a certain network connection to the target network node (150R in FIG. 1C). The target network node executes and responds to the tasks received across the network 112 over the certain network connection from the initiator network node. The tasks may be executed, for example, by the NIC processing circuitry of the target network node, by an external processor of the target network node by an application running on the target network node, another device, and/or combination of the aforementioned.

Processing of a task may include a sequence of request/response commands and/or data units exchanged between initiator and target network nodes. Examples of task-oriented application/upper layer protocol (ULP) include: NVMe over Fabric, and iSCSI. Examples of tasks, which may comprise multiple interactions include: Read_operation, Write_operation_without_immediate_data, and Write_operation_with_immediate_data.

The certain network connections described herein is one of multiple established network connections that are simultaneously existing on the same NIC 192A-B.

Some of the established network connections are simultaneously processing tasks, while others are not processing tasks during the processing of tasks by the other established network connections.

The established network connections may be between the NIC and multiple other network nodes, for example, a central server hosting a web site that is simultaneously accessed by multiple client terminals. Each of the client terminals is using its respective established network connection to download data from the web site, upload data to the web site, or not perform active upload/download of data with the established network connection kept alive. For example, server(s) acting as initiator network node(s) that are connected to a storage controller acting as target network node(s) in order to access shared storage devices.

The network node 150 transfers data over a packet-based network 112 via a network interface 118 using a certain network connection. The certain network connection is one of many other active network connections, some of which may be simultaneously transferring data across the network 112, and others of which are not transferring data at the same time as the certain network connection.

The Network node 150 may be implemented, for example, as a server, a storage controller, and etc.

The network 112 may be implemented as a packet-switch network, for example, a local area network (LAN), and/or a wide area network (WAN). The network 112 may be implemented using wired and/or wireless technologies.

The network interface 118 may be implemented as a software and/or hardware interface, for example one or more of combination of: a computer port (e.g., hardware physical interface for a cable), a network interface controller, a network interface device, a network socket, and/or protocol interface. The NIC 192A or 192B is associated with a memory 106 that assigns a directing context 106D-2, and assigns a network context 106D-1. The directing context 106D-2 refers to a part of the memory 106 defined as a first dynamically allocated memory resource reserved from multiple available allocated memory resources. The network context 106D-1 refers to another part of the memory 106 defined by a second dynamically allocated memory resource reserved from the multiple available allocated memory resources. The directing context 106D-2 is associated with one or more queues 106C queueing multiple tasks designated for execution using a certain network connection of multiple network connections over the packet network 112.

Examples of the memory 106 include random access memory (RAM), for example, dynamic RAM (DRAM), static RAM (SRAM), and so on.

The memory 106 may be located in one or more of: attached to a CPU 150A of external processor 150B, attached to the NIC 192A-B, and/or inside the NIC 192A-B. It is noted that all three possible implementations are depicted in FIG. 1A.

The CPU 150A may be implemented, for example, as a single core processor, a multi-core processor, or a microprocessor.

With respect to the NIC192A, the external processor 150B (and internal components) is external to the NIC 192A. Communication between the NIC192A and the external processor 150B may be, for example, using a software interface over a PCIe bus.

With respect to the NIC192B, the external processor 150B, the CPU 150A, and the memory 106 storing queues 106C, are included within the NIC192B, for example, on the same hardware board. Communication between components of the NIC192B may be implemented, for example, using propriety software and/or hardware interface(s)

The queues 106C are used to deliver task related information originating from an NIC processing circuitry 102 and/or destined to the NIC processing circuitry 102, for example, between the NIC processing circuitry 102 and the external processor 150B. Alternatively, in another example, the NIC processing circuitry 102 queues some tasks for further execution by itself.

Exemplary task related information delivered by the queues 106C include one or more of: task request instructions, task response instructions, data delivery instructions, task completion information, and the like.

The processing circuitry 102 may be implemented, for example, as ASIC, FPGA, and one or more microprocessors.

The directing context 106D-2 stores first state parameters used by the certain network connection during execution of the tasks queued in the queues 106C associated with the directing context 106D-2. An amount of the memory resources reserved for the allocation of the directing context 106D-2 may be determined by a first estimated number of established network connections that are predicted to simultaneously execute respective tasks. Network connections which simultaneously execute tasks are each allocated a respective directing context. Network connections which are established but not executing tasks are not allocated directing context, until execution of tasks is determined to start, as described herein.

The network context 106D-1 stores second state parameters for the certain network connection. The second state parameters are maintained and used by the certain network connection during a whole lifetime of the certain network connection, from when the network connection is established until termination of the network connection, during time intervals of execution of tasks and during intervals when tasks are not being executed (i.e., the network connection remaining established). An amount of memory resources reserved for the allocation of the network context 106D-1 is determined by a second estimated number of concurrently established network connections. Network connections which are established are assigned respective network contexts, regardless of whether tasks are being executed or not. The first and second state parameters comprises a state of a network connection (e.g., context) which is passed between processing of preceding and successive packets (e.g., stateful processing). Stateful processing is dependent on ordering of the processed packets, optionally as close as possible to the order of the packets at the source. Exemplary stateful protocols include: TCP, RoCE, iWARP, iSCSI, NVMe-oF, MPI, and the like. Exemplary stateful operations include: LRO, GRO, and the like. The first state parameters represent the state of the certain network connection required during processing of tasks. First state parameters may be used, for example, to deliver task related information using set of Queues, and/or to provide disorder of the arrived packets, loss recovery, and retransmissions. Second state parameters may be used, for example, to provide network transport and/or network monitoring of congestion mitigation in the network including RTT/Latency, available, and/or reached rates.

As discussed herein, the context of network connection includes a first part and a second part. The first part, which includes directing context and associated queues, is used (optionally only) during the time when tasks are being processed. The second part, which includes the network context, is used during the time when the network connection is alive. The amount of memory reserved for allocation of network contexts may be according to the predicted amount of concurrently established network connections. The amount of memory reserved for the directing contexts (including the queues) may be according to the predicted amount of network connections that are concurrently processing tasks. Each network connection that is processing tasks uses both the first and second parts of the context, i.e., both the network context and the directing context. Directing context is dynamically allocated and/or assigned to network connections (optionally only) during the time interval when task processing is occurring. Since in a high-scale system, the number of network connections that are concurrently processing tasks is significantly less than the total number of network connections, a reduction in reserved memory is achieved by the amount of predicted directing contexts that is significantly less than the amount of predicted network contexts.

Optionally, a network context identifier (NCID) is assigned to the network context 106D-1 and a directing context identifier (SCID) is assigned to the directing context 106D-2.

A Queue Element of the queues 106C includes a task related information of the tasks using the certain network connection together with a respective NCID. Including the NCID in the queue element may improve processing efficiency, since the NCID of the network context associated with the queue element is immediately available and does not require additional access to the mapping dataset to obtain the NCID.

The memory stores a mapping dataset 106B that maps between the NCID of the network context 106D-1 and the SCID of the directing context 106D-2. The mapping dataset 106B may be implemented using a suitable format and/or data structure (e.g. table, set of pointers, hash function). The number of the elements in the mapping dataset may be set according to the supported/estimated number of network connections concurrently processing tasks. Each element of the mapping dataset may store one or more of the following: (i) a validity mark denoting whether the respective element is valid or not, which may initialized as “Not_Valid”; (ii) SCID value, which is set when the element is valid; and (iii) a counter of the tasks applied to the respective element.

The following are exemplary logical operations implemented by the mapping dataset: element ncscGet (NCID), which returns the element from the mapping dataset; and void ncscSet (NCID, element), which sets the element in the mapping dataset At initiator network node the mapping data is managed by the external processor and optionally may be accessed by the NIC processing circuitry. At target network node the mapping dataset is managed by the NIC processing circuitry and optionally may be accessed by the external processor.

When the network node 150 is implemented as an initiator, the tasks are posted to the queue(s) 106C by an external processor 150B. The external processor 150B may receive the tasks from an application running on the network node 150 implemented as initiator. The external processor 150B associates the directing context 106D-2 with the network context 106D-1.

When the network node 150 is implemented as a target, the tasks are received across the network 112 over the certain network connection from an initiator network node (e.g., another instance of the network node 150 implemented as the initiator). The NIC processing circuitry 102 associates the directing context 106D-2 with the network context 106D-1, and queues the tasks into queue 106C associated with directing context 106D-2.

The NIC processing circuitry 102 processes the tasks using the directing context 106D-2 and the network context 106D-1.

The directing context 106D-2 is temporarily assigned for use by the certain network connection during execution of the tasks. The network context 106D-1 is assigned for use by the certain network connection during a lifetime of the certain network connection. The temporary assignment is released upon completion of execution of the tasks, which frees up the directing context for assignment to another network connection, or re-assignment to the same network connection, for execution of another set of tasks. Alternatively, the temporary assignment of the directing context 106D-1 is not released upon completion of execution of the tasks, but is maintained for execution of another set of tasks submitted to the same certain network connection. Alternatively, the temporary assignment of the directing context 106D-1 is not released upon completion of execution of the tasks, but is released when another network connection starts to process another set of tasks.

When the network node 150 is implemented as the initiator, the association of the directing context 106D-2 with the network context 106D-1 is released by the external processor 150B in response to an indication of completing execution of the tasks. When network node 150 is implemented as the target, the association of the directing context 106D-2 with the network context 106D-1 is released by the NIC processing circuitry 102. Release of the association enables the directing context to be used by another network connection executing tasks, or the same network connection to execute another set of tasks.

The assignment of the network context 106D-1 is maintained until the certain network connection is terminated. The certain established network connection may be terminated, for example, gracefully such as closed by a local application and/or closed by a remote application. In another example, the certain established network connection may be terminated abortively, for example, when an error is detected. When the network connection has terminated, the released network context may be assigned to another network connection that is established.

When the NIC 192A or 192B is implemented on the target network node, the NIC processing circuitry 120 performs the following: Determining start of processing of a first task using the certain network connection. Allocating the directing context 106D-2 from the memory resources for use by the certain network connection and associating the directing context 106D-2 (optionally having the certain SCID) with the network context 106D-1 (optionally having the certain NCID). The associating is performed by creating a mapping between the network context 106D-1 and the directing context 106D-2 (e.g. a mapping between the NCID and the SCID), in response to the determined start. The mapping may be stored in mapping dataset 106B. All of the tasks are processed using the same mapping. Determining completion of a last task of the tasks. In response to the determined completion, optionally releasing the association of the directing context 106D-2 with the network context 106D-1 by removing the mapping between the network context 106D-1 and the directing context 106D-2, (e.g. the mapping between the NCID and the SCID), and releasing the directing context 106D-2.

Referring now back to FIG. 1B, an implementation 190A includes the NIC 192A (e.g., as in FIGS. 1A and 1C), and an implementation 190B includes the NIC 192B (e.g., as in FIGS. 1A and 1C). The implementations 190A and 190B may be used for the initiator network node and/or for the target network node.

The implementation 190A is now discussed in detail. The NIC192A (also referred to herein as SmartNIC, or sNIC), includes a processing circuitry 102, the memory 106, and the network interface 118, as described with reference to FIG. 1A. A host 150B-1 corresponds to external processor 150B described with reference to FIG. 1A. A host 150B-1 includes the CPU 150A and the memory 106 storing queues 106C, as described with reference to FIG. 1A. The NIC192A and the host 150B-1 are two separate hardware components, connected, for example, by a PCIe interface.

The host 150B-1 may be implemented, for example, as a server,

When the implementation 190A is used with the initiator network node, the host 150B-1 performs the following, and alternatively or additionally when implementation 190A is used with the target network node, the processing circuitry 102 performs the following: Determining start of processing of a first task of the tasks using the certain network connection. Allocating the directing context from the memory resources for use by the certain network connection. Associating the directing context (optionally having a certain SCID) with the network context (optionally having a certain NCID) by creating a mapping between the directing context and the network context (e.g. a mapping between the respective NCID and SCID) in response to the determined start. The mapping may be stored in mapping dataset 106B described with reference to FIG. 1A. All of the tasks are processed using the same mapping. Determining completion of a last task of the tasks. In response to the determined completion, releasing the association of the directing context with the network context by removing the mapping between the directing context and the network context (e.g. the mapping between the NCID and the SCID), which may be stored in the mapping dataset) and releasing the directing context. It is noted that directing context and network context refer to elements 106D-2 and 106D-1 described with reference to FIG. 1A.

The implementation 190B, which includes the NIC192B, which is a smart NIC is now discussed in detail. It may be referred to herein as a network processor unit (NPU) 160A. The network processor unit (NPU) 160A may include a processing circuitry 102, a memory 106, and a network interface 118. NIC192B further includes a service processor unit (SPU) 150B-2. The SPU 150B-2 corresponds to the external processor 150B described with reference to FIG. 1A. The NPU 160A and the SPU 150B-2 are located on the same hardware component, for example, the same network interface hardware card.

The SPU 150B-2 may be implemented, for example, as an ASIC, FPGA, and CPU.

The NPU 160A may be implemented, for example, as an ASIC, FPGA, and/or one or more microprocessors.

The NIC192B is in communication with a host 194, which includes a CPU 194A and a memory 194B. The Memory 194B stores an external set of queues 194C, which are different than the queues 106C. The host 194 and the NIC192B may communicate through a set of Queues 194B.

When the implementation 190B is used with the initiator network node, the SPU 150-B performs the following, and alternatively or additionally when the implementation 190B is used with the target network node, the processing circuitry 102 performs the following: Determining start of processing of a first task of tasks using the certain network connection. Allocating a directing context from the memory resources for use by the certain network connection. Associating the directing context (optionally having a certain SCID) with the network context (optionally having a certain NCID) by creating a mapping (between the respective NCID and SCID) in response to the determined start. The mapping may be stored in the mapping dataset 106B described with reference to FIG. 1A, where all of the tasks are processed using the same mapping. Determining completion of a last task of the tasks. In response to the determined completion, releasing the association of the directing context with the network context by removing the mapping (between the NCID and the SCID, which may be stored in the mapping dataset) and releasing the directing context.

Referring now back to FIG. 1C, the initiator node 150Q and the target node 150R may communicate across the network 112 using reliable network connections, for example, RoCE RC/XRC, TCP, and CoCo.

Referring now back to FIG. 2, at 202, a directing context and network context are provided.

The directing context is associated with the network context, and the directing context is associated with one or more queues queueing tasks designated for execution using a certain network connection.

When the method is implemented by a NIC of an initiator network node, the tasks are posted to the queue(s) by an external processor. The external processor determines start of processing of the first task of the tasks using the certain network connection, and allocates the directing context from the memory resources for use by the certain network connection, and associate the directing context (optionally having a certain SCID) with the network context (optionally having a certain NCID) by creating a mapping (between the NCID and the SCID) in response to the determined start.

When the method is implemented by a NIC of a target network node, the tasks are received across the network over the certain network connection from an initiator network node. The NIC processing circuitry of the NIC of the target network node determines start of processing of the first task of the tasks using the certain network connection, and allocates the directing context from the memory resources for use by the certain network connection, and associate the directing context (optionally having a certain SCID) with the network context (optionally having a certain NCID) by creating a mapping (between the NCID and the SCID) in response to the determined start.

At 204, the directing context is temporarily assigned for use by the certain network connection during execution of the tasks.

At 206, the network context is assigned for use by the certain network connection during a lifetime of the certain network connection.

At 208, the tasks are processed using the directing context and the network context. All of the tasks are processed using the same mapping.

At 210, an indication of completing execution of the tasks is received

At 212, the association of the directing context with the network context is released while maintaining the assignment of the network context until the certain network connection is terminated.

When the method is implemented by the NIC of the initiator network node, the completion of execution of the last task of the tasks is determined by the external processor, and the release is performed by the external processor.

When the method is implemented by a NIC of the target network node, the completion of execution of the last task of the tasks is determined by the NIC processing circuitry, and the release is performed by the NIC processing circuitry.

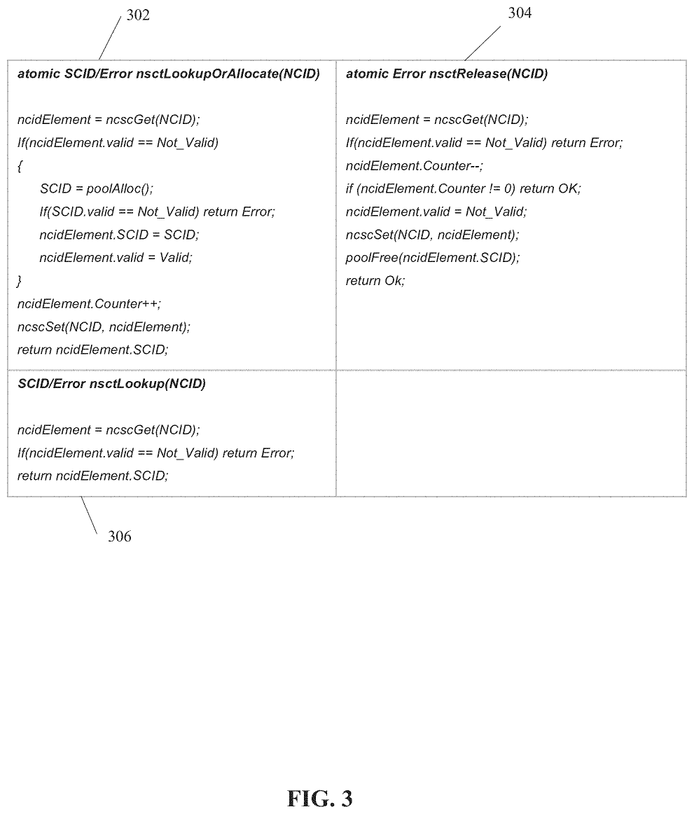

Reference is now made to FIG. 3, which includes exemplary pseudocode for implementation of exemplary atomic operations executable by the mapping dataset, in accordance with some embodiments.

The SCID/Error nsctLookupOrAllocate(NCID) 302 operation may be applied at the beginning of tasks to find the SCID associated with the given NCID and/or to create the NCID-SCID association when such association doesn't exist.

The Error nsctRelease(NCID) 304 operation may be applied at the completion of the tasks to release the NCID-SCID association.

The SCID/Error nsctLookup(NCID) 306 operation may be applied in the middle of the tasks to find SCID associated with the given NCID.

Exemplary implementations of the mapping dataset are now discussed.

An exemplary implementation is a solely hardware implementation of all mapping dataset operations by ASIC logic of the sNIC.

Another implementation is a pure software solution by firmware running within the sNIC. An execution of nsctLookupOrAllocate and nsctReleaseByNCID primitives requires to lock NCID related processing flow, and a single flow performance issue may arise. But assuming that in a high-scale system the probability of two concurrent operations on the same flow is not so high, this option is acceptable for some deployments.

For the sole hardware and pure software implementations, the following simplification may be done: to take poolAlloc and poolFree operations out of the atomicity boundary. It is noted there may be a short-term lack of SCID in the system, but full consistency of the operations is provided.

Yet another implementation is based on a combined software-hardware implementation using RDMA atomic primitives. Such solution is applicable with the following assumptions:
Not more than 64K−1 outstanding transactions shall be supported. When the assumption holds, not more than 64K−1 SCID is required.
When the assumption holds and the counter is of less than 4 bytes: >2 bytes for SCID+>2 bytes for the counter.
The value 0xFFFF means invalid SCID and 0xFFFF0000 (NOT_VALID_VAL)— the counter is invalid.
The following are exemplary atomic primitives:
   OriginalVal atomicAdd(Counter_ID, incremental_value);
   OriginalVal atomicDec(Counter_ID, incremental_value);
      It's the version of atomicAdd, which doesn't go below 0. Below zero it's in use for the visibility of the explanation; in the implementation may block the bugs.
   OriginalVal atomicCAS(Counter_ID, Compare, Swap);
The cost is the additional reads of the counter.

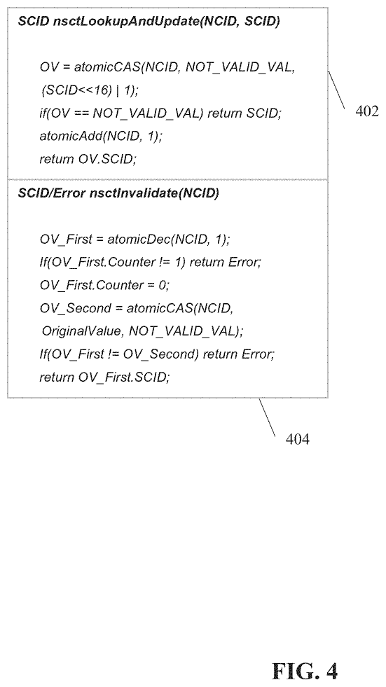

Reference is now made to FIG. 4, which includes exemplary pseudocode for implementation of exemplary operations executable by the mapping dataset in accordance with some embodiments. Pseudocode is provided for implementing the operation SCID nsctLookupAndUpdate (NCID, SCID) 402 and SCID/Error nsctInvalidate(NCID) 404. The term OV denotes an original value. For SCID/Error nsctInvalidate (NCID) 404, after the decrement the counter is 0, so the entry may be invalidated, but perhaps some parallel processing has inserted in the middle using the operation nsctLookupAndUpdate and increased the counter. In such case SCID is not released.

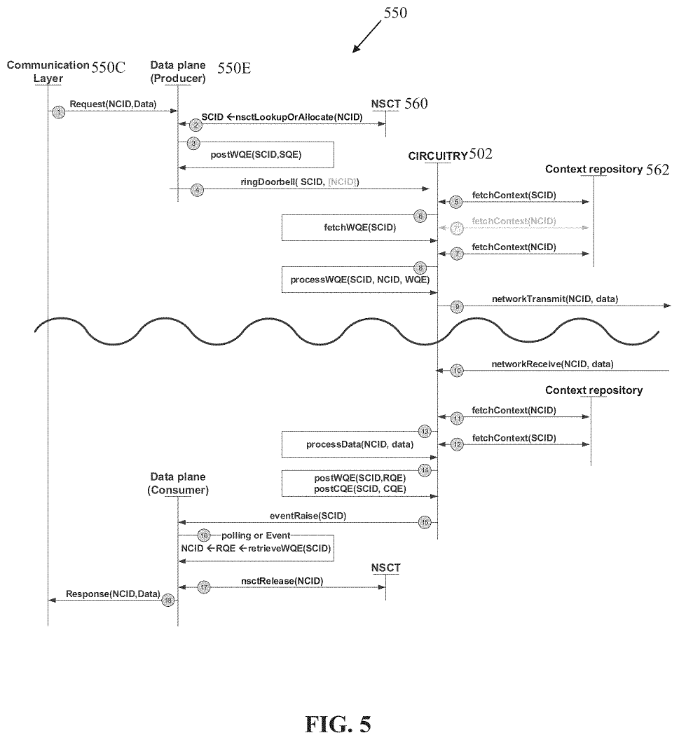

Reference is now made to FIG. 5, which is a diagram depicting an exemplary processing flow in an initiator network node that includes the NIC described herein, in accordance with some embodiments. Components of the processing flow diagram may correspond to components of system 100 described with reference to FIG. 1A-C, and/or may implement features of the method described with reference to FIG. 2. Initiator node 550 corresponds to initiator node 150Q of FIG. 1C. Communication layer 550C may correspond to host 150B-1 and/or to host 194 of FIG. 1B and/or be a part of the application in communication with external processor 150B of FIG. 1A. Data plane (e.g., producer) 550E may correspond to external processor 150B of FIG. 1A. NSCT 560 may correspond to a mapping dataset 106B of FIG. 1A. Offloading circuitry 502 may correspond to NIC processing circuitry 102 of FIG. 1A. Context repository 562 may correspond to memory 106 storing the first allocable resources 106D-2 and second allocable resources 106D-1 of FIG. 1A.

The processing flow at the initiating node is as follows:

At (1), Communication layer 550C submits new tasks for processing using network connection NCID.

At (2), the task processing starts. Data plane 550E performs a lookup for the SCID using the NSCT primitive of the NSCT mapping dataset. When there is no entry in the mapping dataset, a new directing context assigned with SCID is allocated and associated with the NCID of the network context assigned to the network connection, otherwise the existing association is used.

At (3), Data plane 550E initializes and posts new tasks to the queue associated with the Directing context. The actual value of NCID is a part of a task related information of the posted working queue element (WQE).

At (4), Data plane 550E ring the doorbell to notify Offload circuitry 502 about non-empty queue associated with the Directing context.

At (5), Offload circuitry 502 starts to process arrived doorbell, by fetching the Directing context from context repository 562 using SCID from doorbell.

At (6), Offload circuitry 502 fetches the WQE from the SQ using state information of the Directing context. The WQE carries the proper NCID value.

At (7), Offload circuitry 502 fetches Network Context using NCID from WQE.

At (7′), Offload circuitry 502 fetches the Network Context using NCID from doorbell. Flow 7′ denotes a flow optimization that may be applicable in the case when the doorbell information contains also NCID.

Step (7′) may be executed concurrently with step (5) BEFORE (6) is completed.

At (8), Offload circuitry 502 processes tasks by downloading data, segmenting the data, calculating the CSC/checksums/digests, formatting packets, headers, and the like; updating congestion state information, RTT calculation and the like; updating Steering and Network Context state information, and saving the NCID← →SCID reference in the corresponding contexts.

At (9), Offload circuitry 502 transmits the packets across the network.

At (10), Offload circuitry 502 processes the arrived response packets received across the network and obtains NCID (directly or indirectly) using the information in the received packet. Direct obtaining of NCID examples include: using QPID of RoCE header, and CoCo option of TCP header. Indirect examples include: lookup NCID by 5 tuple key build from TCP/IP headers of the packet

At (11), Offload circuitry 502 fetches the Network Context using NCID from context repository 562. The Network Context includes the attached SCID value.

At (12), Offload circuitry 502 fetches Directing context using SCID obtained from the Network Context.

At (13), Offload circuitry 502 performs packet processing using the Network Context state information by: updating the congestion state information, RTT calculation and the like; and clearing the NCID← →SCID reference in context.

At (14), Offload circuitry 502 performs packet processing using the Directing context state information, by: posting working element with the task response related information into the RQ; posting working elements with task request/response completion information into the CQ; and clearing the NCID← →SCID reference in context.

At (15), Offload circuitry 502 notifies Data plane 550E about task execution completion.

At (16), Data plane 550E is invoked by interrupt or CQE polling denoting that the task has ended. Data plane 550E retrieves completion information using CQE, retrieved NCID from RQE.

At (17), Data plane 550E releases SCID to NCID mapping using NSCT primitives.

At (18), Data plane 550E submits the task response to Communication Layer 550C.

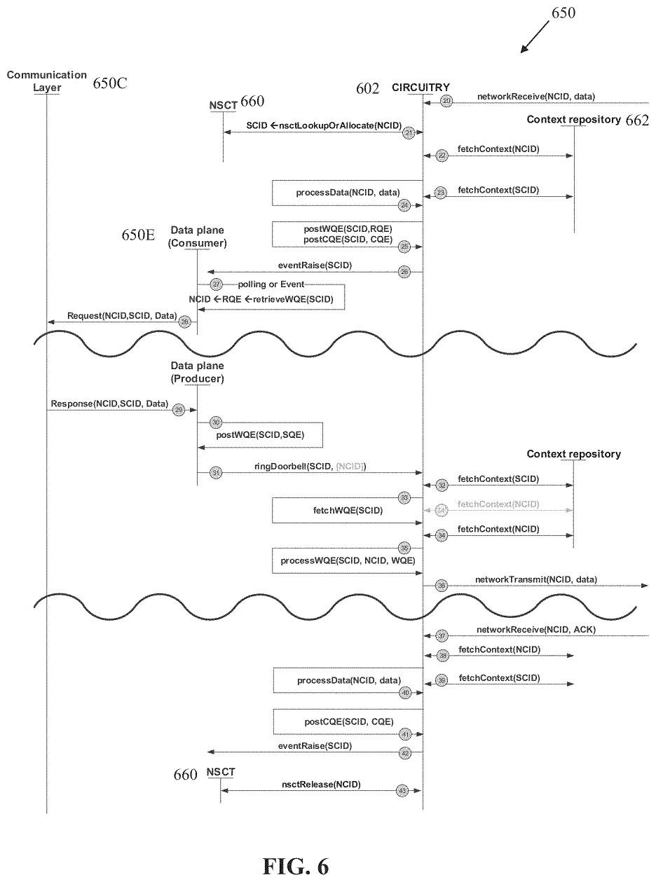

Reference is now made to FIG. 6, which is a processing flow diagram depicting an exemplary processing flow in a target network node that includes the NIC described herein, in accordance with some embodiments. Components of the processing flow diagram may correspond to components of system 100 described with reference to FIG. 1A-C, and/or may implement features of the method described with reference to FIG. 2. Target node 650 corresponds to target node 150R of FIG. 1C. Communication layer 650C may correspond to host 150B-1 and/or to host 194 of FIG. 1B and/or to an application in communication with external processor 150B of FIG. 1A. Data plane (e.g., consumer) 650E may correspond to external processor 150B of FIG. 1A. NSCT 660 may correspond to mapping dataset 106B of FIG. 1A. Offloading circuitry 602 may correspond to NIC processing circuitry 102 of FIG. 1A. Context repository 662 may correspond to memory 106 storing the first allocable resources 106D-2 and second allocable resources 106D-1 of FIG. 1A.

The processing flow at the target node is as follows:

At (20), Offload circuitry 602 processes the arrived task initiation packet(s), indicating that a task processing is started. Offload circuitry 602 obtains NCID (directly or indirectly) using information in the packet. Direct obtaining of NCID examples include: using QPID of RoCE header, and CoCo option of TCP header. Indirect examples include: lookup NCID by 5 tuple key build from TCP/IP headers of the packet

At (21) Offload circuitry 602 performs a lookup for the SCID using NSCT primitive of the NSCT mapping dataset 660. When there is no entry in the mapping dataset, a new directing context is allocated and its SCID is associated with the network context having requested NCID, otherwise existing association is used.

At (22), Offload circuitry 602 fetches Network Context using NCID from context repository 662. In case the Network Context includes a valid SCID reference, its value should be verified vs. the SCID retrieved by the lookup primitive in (21).

At (23), Offload circuitry 602 fetches the Directing context from context repository 662 using the SCID obtained by lookup primitive. It is noted that (23) may be done concurrently with (22) as soon as (21) results are known.

At (24), Offload circuitry 602 performs packet processing using the Network Context state information, by updating congestion state information, RTT calculation and the like; and updating the NCID← →SCID reference in context.

At (25), Offload circuitry 602 performs packet processing using the Directing context state information, by posting a working element with the task request related information to RQ; posting a working element with completion information to CQ to queue; and updating the NCID← →SCID reference in context.

At (26), Offload circuitry 602 notifies Data plane 650E (acting as a consumer) about task execution completion.

At (27), Data plane 650E is invoked by interrupt or CQE polling, and retrieves completion information using CQE, retrieved NCID from RQE.

At (28), Data plane 650E submits a task request to Communication Layer 650C along with actual values of {NCID, SCID}.

At (29), Communication Layer 650C, after serving of the arrived request, submits the task response to Data plane 650E (acting as a producer) using the pair {NCID, SCID} from the request.

At (30), Data plane 650E is initialized and posts task response to the queue associated with the Directing context. The actual value of NCID is a part of task response information within posted WQE.

At (31), Data plane 650E rings the doorbell to notify Offload circuitry 602 about non-empty queue associated with the Directing context.

At (32), Offload circuitry 602 starts to process arrived doorbell, by fetching the Directing context using SCID from the doorbell.

At (33), Offload circuitry 602 fetches WQE from the SQ using state information of the Directing context. WQE carries the proper NCID value.

At (34), Offload circuitry 602 fetches the Network Context using NCID from WQE.

At (34′), Offload circuitry 602 fetches the Network Context using NCID from doorbell. It is noted that (34′) is a flow optimization that is applicable in a case where the doorbell information contains also NCID. (34′) may be executed concurrently with step (32) before (33) is completed.

At (35), Offload circuitry 602 processes the task, by downloading data, segmenting the data, calculating CSC/checksums/digests, format packets, headers, and the like; updating congestion state information, RTT calculation and the like; and updating Steering and Network Context state information.

At (36), Offload circuitry 602 transmits packets across the network.

At (37), Offload circuitry 602 processes arrived acknowledgement packet indicating that the task is completed. Offload circuitry 602 obtains NCID (directly or indirectly) using information in the received packet. Direct obtaining of NCID examples include: using QPID of RoCE header, and CoCo option of TCP header. Indirect examples include: lookup NCID by 5 tuple key build from TCP/IP headers of the packet.

At (38), Offload circuitry 602 fetches the Network Context using NCID.

At (39), Offload circuitry 602 fetches the Directing context using SCID.

At (40), Offload circuitry 602 process acknowledgements by updating the Steering and Network Context state information, and clearing the NCID← →SCID references in context

At (41), Offload circuitry 602 posts a working element comprising task completion information to CQ.

At (42), Offload circuitry 602 notifies Data plane 650E about the completion of the task response.

At (43), Offload circuitry 602 releases the SCID to NCID mapping using NSCT primitives.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant NICs will be developed and the scope of the term NIC is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the present disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable sub-combination or as suitable in any other described embodiment of the present disclosure. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A network interface card, NIC, for data transfer across a network, comprising:
a memory (106), configured to assign a directing context denoting a first dynamically allocated memory resource and assign a network context denoting a second dynamically allocated memory resource, wherein the directing context is associated with the network context by an external processor, and the directing context is associated with at least one queue with a plurality of tasks, wherein the plurality of tasks are posted by the external processor and designated for execution using a certain network connection;
a NIC processing circuitry, configured to process the plurality of tasks using the directing context and the network context,
wherein the directing context is temporarily assigned for use by the certain network connection during execution of the plurality of tasks, wherein the network context is assigned for use by the certain network connection during a lifetime of the certain network connection; and
in response to an indication of completing execution of the plurality of tasks, the association of the directing context with the network context is released by the external processor while maintaining the assignment of the network context until the certain network connection is terminated.

2. The NIC of claim 1, wherein the directing context is further configured to store a plurality of first state parameters, wherein the plurality of first state parameters are used by the certain network connection during execution of the plurality of tasks queued in the at least one queue associated with the directing context.

3. The NIC of claim 1, wherein an amount of the memory resources reserved for the allocation of the directing context is determined by a first estimated number of established network connections that are predicted to simultaneously execute respective tasks.

4. The NIC of claim 1, wherein the network context is configured to store a plurality of second state parameters for the certain network connection, wherein the plurality of second state parameters are maintained and used by the certain network connection during a whole lifetime of the certain network connection.

5. The NIC of claim 1, wherein an amount of memory resources reserved for the allocation of the network context is determined by a second estimated number of concurrently established network connections.

6. The NIC of claim 1, wherein a network context identifier, NCID, is assigned to the network context and a directing context identifier, SCID, is assigned to the directing context.

7. The NIC of claim 6, wherein the at least one queue is used to deliver task related information originated from the NIC processing circuitry and/or destined to the NIC processing circuitry, wherein a Queue Element of the at least one queue includes a task related information of the plurality of tasks using the certain network connection together with a respective NCID.

8. The NIC of claim 6, wherein the memory is configured to store a mapping dataset that maps between the NCID of the network context and the SCID of the directing context.

9. The NIC of claim 6, wherein the external processor is configured to:
determine start of processing of a first task of the plurality of tasks using a certain network connection;
allocate a directing context from the plurality of the memory resources for use by the certain network connection; and
associate the directing context having a certain SCID with the network context having a certain NCID by creating a mapping between the respective NCID and SCID in response to the determined start, wherein all of the plurality of tasks are processed using the same mapping.

10. A network interface card, NIC, for data transfer across a network, comprising:
a memory, configured to assign a directing context denoting a first dynamically allocated memory resource and assign a network context denoting a second dynamically allocated memory resource, wherein the directing context is associated with at least one queue with a plurality of tasks, wherein the plurality of tasks are received across the network from an initiator network node over a certain network connection;
a NIC processing circuitry, configured to:
associate the directing context with the network context; and
queue the plurality of tasks into at least one queue associated with the directing context;
wherein the directing context is temporarily assigned for use by the certain network connection during execution of the plurality of tasks, wherein the network context is assigned for use by the certain network connection during a lifetime of the certain network connection; and
in response to an indication of completing execution of the plurality of tasks, release the association of the directing context with the network context while maintaining the assignment of the network context until the certain network connection is terminated.

11. The NIC of claim 10, wherein the directing context is further configured to store a plurality of first state parameters, wherein the plurality of first state parameters are used by the certain network connection during execution of the plurality of tasks queued in the at least one queue associated with the directing context.

12. The NIC of claim 10, wherein an amount of the memory resources reserved for the allocation of the directing context is determined by a first estimated number of established network connections that are predicted to simultaneously execute respective tasks.

13. The NIC of claim 10, wherein the network context is configured to store a plurality of second state parameters for the certain network connection, wherein the plurality of second state parameters are maintained and used by the certain network connection during a whole lifetime of the certain network connection.

14. The NIC of claim 10, wherein an amount of memory resources reserved for the allocation of the network context is determined by a second estimated number of concurrently established network connections.

15. The NIC of claim 10, wherein a network context identifier, NCID, is assigned to the network context and a directing context identifier, SCID, is assigned to the directing context.

16. The NIC of claim 15, wherein the at least one queue is used to deliver task related information originated from the NIC processing circuitry and/or destined to the NIC processing circuitry, wherein a Queue Element of the at least one queue includes a task related information of the plurality of tasks using the certain network connection together with a respective NCID.

17. The NIC of claim 15, wherein the memory is configured to store a mapping dataset that maps between the NCID of the network context and the SCID of the directing context.

18. The NIC of claim 15, wherein the NIC processing circuitry is configured to:
determine start of processing of a first task of the plurality of tasks using the certain network connection; and
allocate the directing context from the plurality of the memory resources for use by the certain network connection and associate the directing context having a certain SCID with the network context having a certain NCID by creating a mapping between the NCID and the SCID in response to the determined start, wherein all of the plurality of tasks are processed using the same mapping.

19. A method of management of resources consumed by a network connection for processing of tasks across a network, wherein the method is applied to a network interface card, NIC, and comprising:
providing a directing context denoting a first dynamically allocated memory resource and providing a network context denoting a second dynamically allocated memory resource, wherein the directing context is associated with the network context, and the directing context is associated with at least one queue queueing a plurality of tasks, wherein the plurality of tasks are designated for execution using a certain network connection;
temporarily assigning the directing context for use by the certain network connection during execution of the plurality of tasks;
assigning the network context for use by the certain network connection during a lifetime of the certain network connection;
processing the plurality of tasks using the directing context and the network context; and
in response to an indication of completing execution of the plurality of tasks, releasing the association of the directing context with the network context while maintaining the assignment of the network context until the certain network connection is terminated.
